(19) United States
(12) Patent Application Publication
(10) Pub. No.: US 2025/0288130 A1
(43) Pub. Date: Sep. 18, 2025

(54) Puzzle Holding Device

(71) Applicants: Bruce Compton, New Ulm, MN (US); Shane Compton, New Ulm, MN (US)

(72) Inventors: Bruce Compton, New Ulm, MN (US); Shane Compton, New Ulm, MN (US)

(21) Appl. No.: 19/051,661

(22) Filed: Feb. 12, 2025

Related U.S. Application Data
(60) Provisional application No. 63/566,175, filed on Mar. 15, 2024.

(51) Int. Cl. A47F 7/00; A63F 9/08; F16M 11/12

(52) U.S. Cl. CPC A47F 7/00; F16M 11/126; A47F 2007/0092; A63F 9/0826

(57) ABSTRACT

A puzzle holding device for selectively restricting orientational movement of three-dimensional puzzles includes a base. A first arm is coupled to the base. A second arm is coupled to the base. The second arm is aligned with the first arm across the base. A tube is coupled to the first arm and the second arm wherein the tube is suspended over the base between the first arm and the second arm. The tube is pivotably coupled to the first arm and the second arm wherein the tube is pivotable along an axis extending between a front edge and a rear edge of the base. A holder is coupled to the tube. The holder is configured to couple a three-dimensional puzzle to the tube.

### CROSS-REFERENCE TO RELATED APPLICATIONS

I hereby claim the benefit under 35 U.S.C. Section 119 (e) of U.S. Provisional application No. 63/566,175, filed Mar. 15, 2024.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to puzzle stands and more particularly pertains to a new puzzle stand for selectively restricting orientational movement of three-dimensional puzzles.

### (2) Description of Related Art Including Information Disclosed Under 37 CFR 1.97 and 1.98

The prior art relates to puzzle stands. Puzzle stands are often used to display or store three-dimensional puzzles, such as RUBIK'S CUBES®. For example, after a user solves the puzzle, the user may store the puzzle on a stand to display their success. Individuals who enjoy solving these three-dimensional puzzles often appreciate the intellectual challenge posed by these puzzles. However, for users with a high level of experience, solutions can become predictable, reducing the amount of excitement felt by the user when they successfully solve the puzzle. Thus, there is a need in the art for a device that can selectively increase the difficulty of these three-dimensional puzzles. Ideally, such a device would also be able to hold the puzzle for display or storage.

### BRIEF SUMMARY OF THE INVENTION

An embodiment of the disclosure meets the needs presented above by generally comprising a base. A first arm is coupled to the base. A second arm is coupled to the base. The second arm is aligned with the first arm across the base. A tube is coupled to the first arm and the second arm wherein the tube is suspended over the base between the first arm and the second arm. The tube is pivotably coupled to the first arm and the second arm wherein the tube is pivotable along an axis extending between a front edge and a rear edge of the base. A holder is coupled to the tube. The holder is configured to couple a three-dimensional puzzle to the tube.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a puzzle holding device according to an embodiment of the disclosure.

FIG. 2 is a front view of an embodiment of the disclosure.

FIG. 3 is a top view of an embodiment of the disclosure.

FIG. 4 is an exploded view of an embodiment of the disclosure.

FIG. 5 is a detail view of an embodiment of the disclosure.

FIG. 6 is a detail view of an embodiment of the disclosure.

FIG. 7 is a detail view of an embodiment of the disclosure.

FIG. 8 is a detail view of an embodiment of the disclosure.

FIG. 9 is a detail view of an embodiment of the disclosure.

FIG. 10 is a detail view of an embodiment of the disclosure.

FIG. 11 is a cross-sectional detail view of an embodiment of the disclosure.

FIG. 12 is a cross-sectional detail view of an embodiment of the disclosure.

FIG. 13 is a detail view of an embodiment of the disclosure.

FIG. 14 is a detail view of an embodiment of the disclosure.

FIG. 15 is a detail view of an embodiment of the disclosure.

FIG. 16 is a detail view of an embodiment of the disclosure.

FIG. 17 is a detail view of an embodiment of the disclosure.

FIG. 18 is a detail view of an embodiment of the disclosure.

FIG. 19 is a detail view of an embodiment of the disclosure.

FIG. 20 is a detail view of an embodiment of the disclosure.

### DETAILED DESCRIPTION OF THE INVENTION

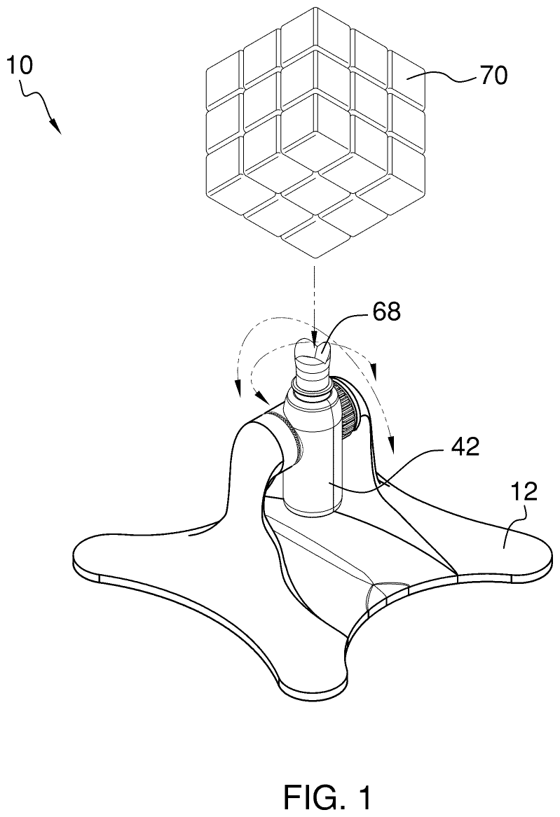

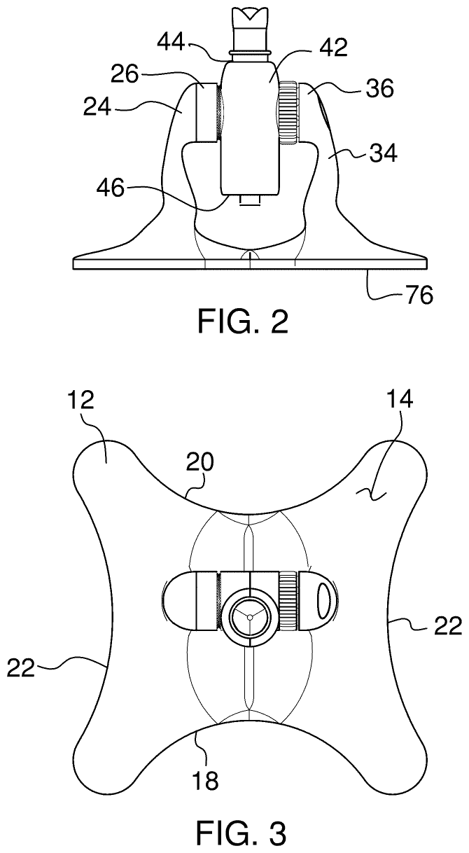

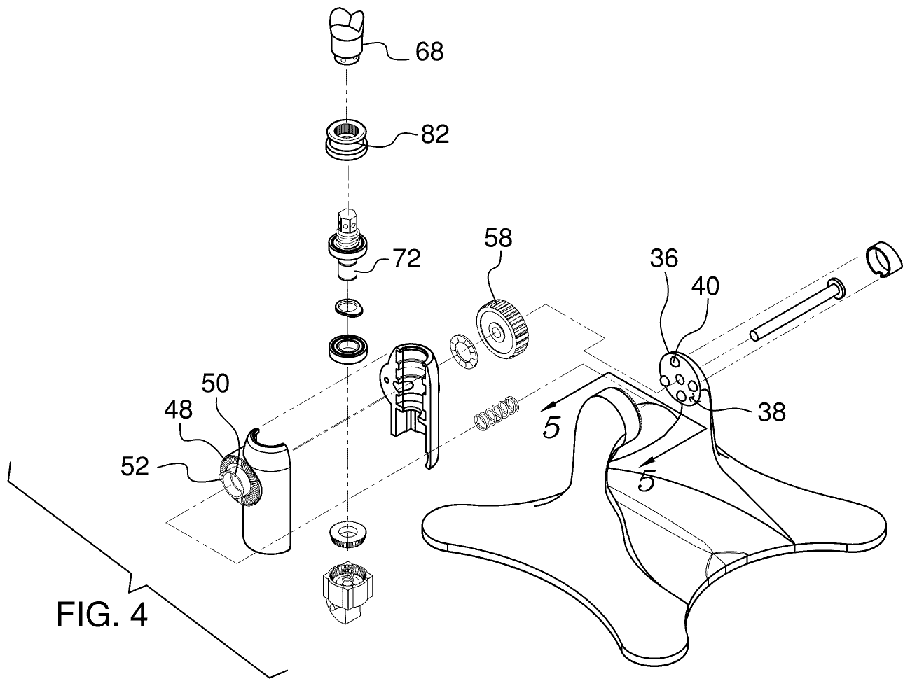

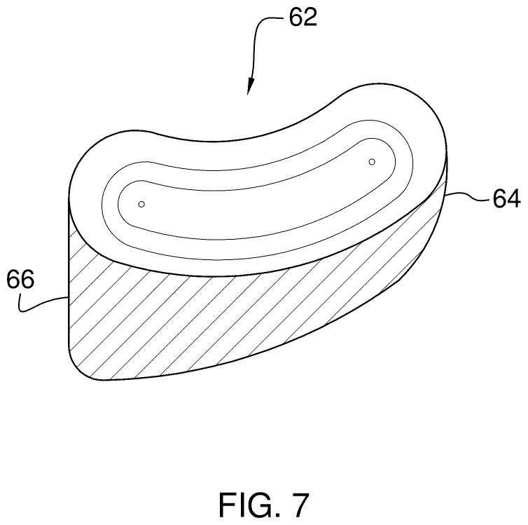

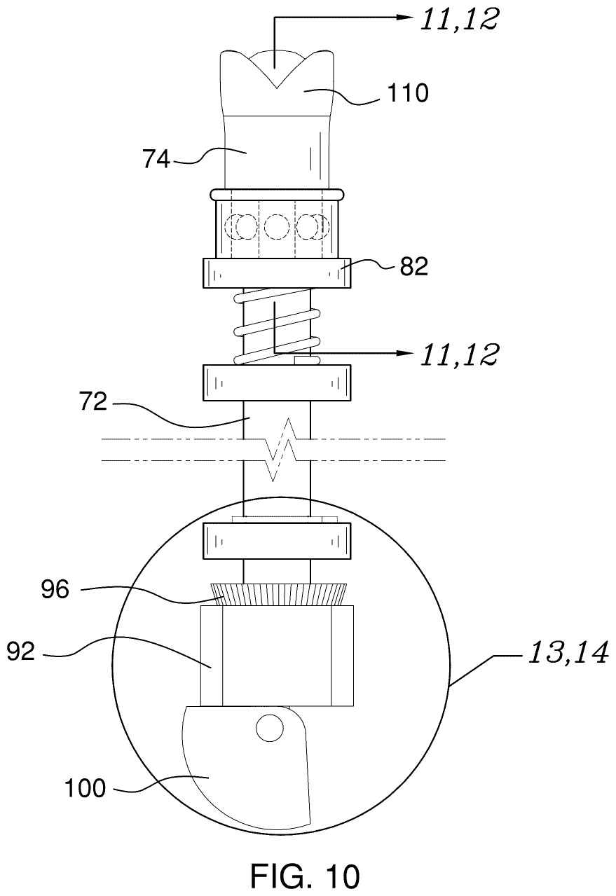

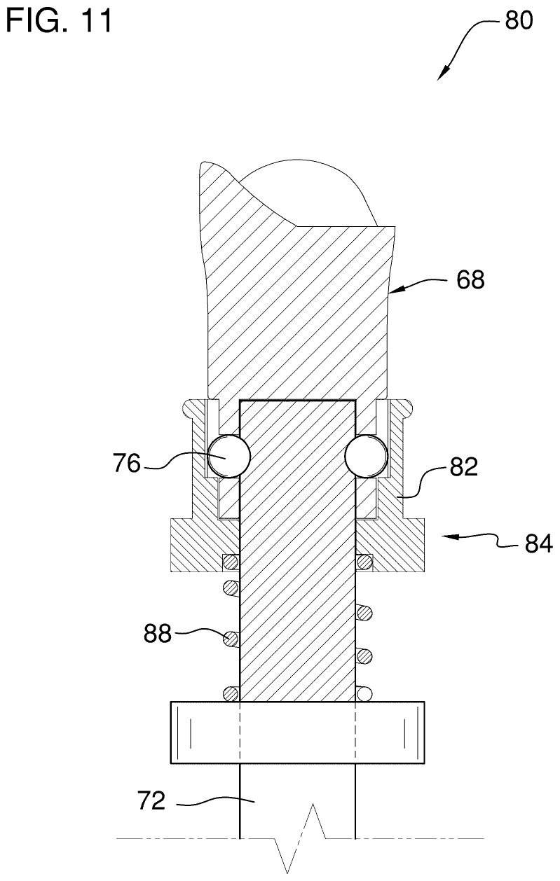

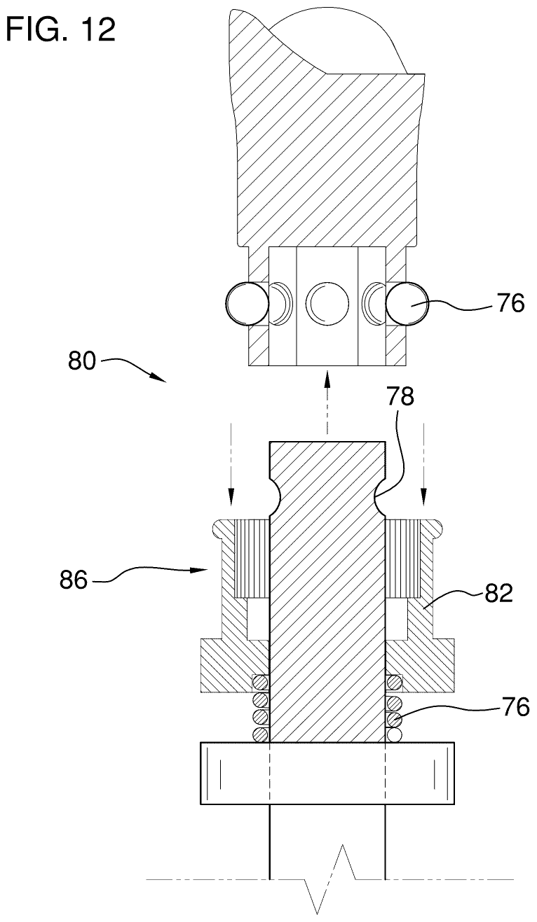

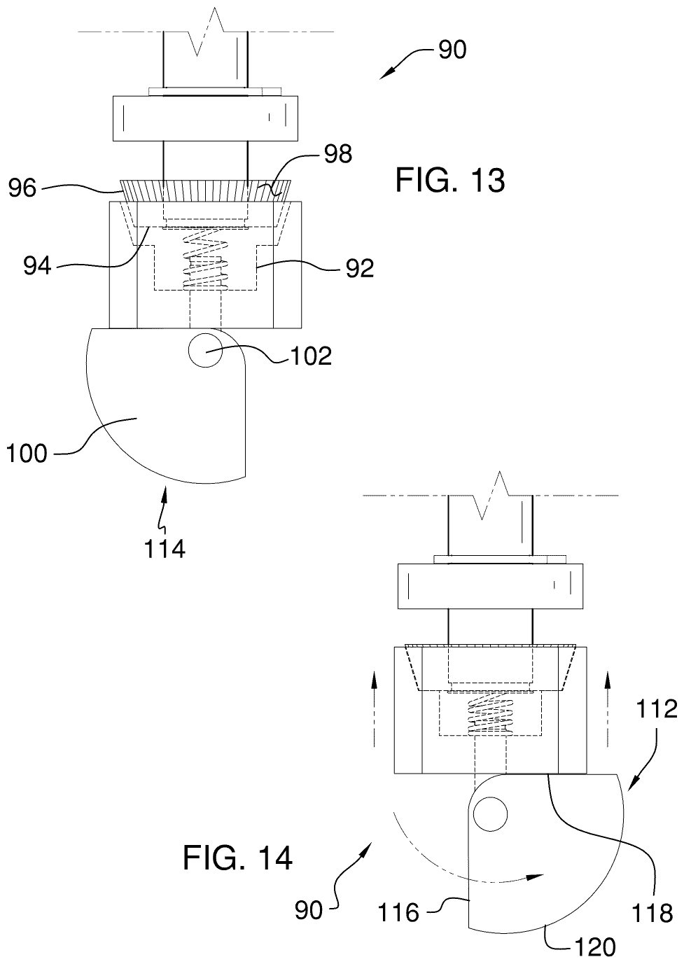

With reference now to the drawings, and in particular to FIGS. 1 through 20 thereof, a new puzzle stand embodying the principles and concepts of an embodiment of the disclosure and generally designated by the reference numeral 10 will be described.

As best illustrated in FIGS. 1 through 20, the puzzle holding device 10 generally comprises a base 12. The base 12 generally includes a top side 14 and a bottom side 16. The base 12 also generally includes a front edge 18, a rear edge 20, and a pair of lateral edges 22 that are coupled to and extend between the front edge 18 and the rear edge 20. The bottom side 16 may be planar wherein the bottom side 16 is configured to be positioned on a surface, such as a table, a desk, or a countertop.

A first arm 24 is coupled to the base 12. The first arm 24 generally extends upwardly from the top side 14. The first arm 24 may be positioned proximate to a first lateral edge of the pair of lateral edges 22.

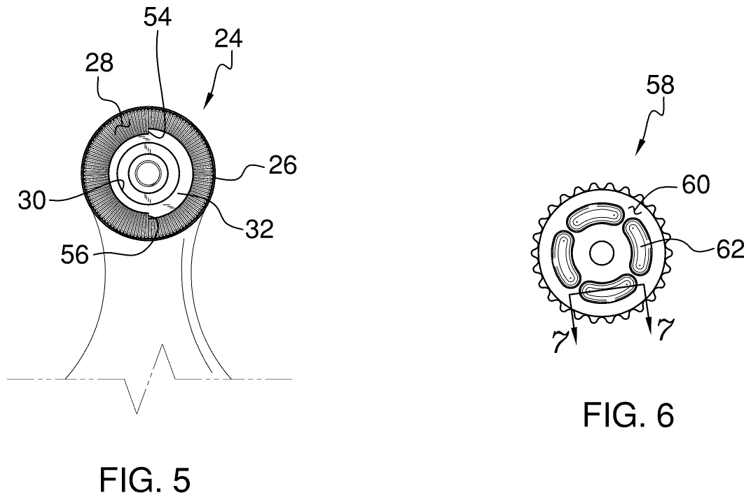

The first arm 24 may include an upper end 26 that has an exposed surface 28. The exposed surface 28 may face away from the first lateral edge of the pair of lateral edges 22. The exposed surface 28 is generally threaded, as shown in FIG. 5. A cavity may extend into the exposed surface 28 of the first arm 24. The cavity 30 may be circular. A channel 32 may extend into the exposed surface 28 of the first arm 24. The channel 32 may be positioned adjacent to the cavity 30. The channel 32 generally has an upper edge 54 and a lower edge 56. The upper edge 54 may be vertically aligned with the lower edge 56 wherein the channel 32 extends 180.0° around the cavity 30, as shown in FIG. 5. In other words, the channel 32 may be semi-circular and extend around one-half of the perimeter of the cavity 30.

A second arm 34 is coupled to the base 12. The second arm 34 generally extends upwardly from the top side 14 of the base 12. The second arm 34 is generally spaced from the first arm 24. For example, the second arm 34 may be positioned proximate to a second lateral edge of the pair of lateral edges 22. The second arm 34 is also generally aligned with the first arm 24 across the base 12. The second arm 34 may have a height that is equal to a height of the first arm 24.

The second arm 34 may include a top end 36 that has a forward surface 38. The forward surface 38 may face away from the second lateral edge of the pair of lateral edges 22. In other words, the forward surface 38 generally faces toward the exposed surface 28 of the first arm 24. A plurality of cusps 40 may be positioned on the forward surface 38 of the top end 36. The plurality of cusps 40 generally extend outwardly from the forward surface 38. The plurality of cusps 40 are generally spaced from each other.

A tube 42 is coupled to the first arm 24 and the second arm 34 wherein the tube 42 is suspended over the base 12 between the first arm 24 and the second arm 34. The tube 42 is generally pivotably coupled to the first arm 24 and the second arm 34 wherein the tube 42 is pivotable along an axis extending between the front edge 18 and the rear edge 20 of the base 12.

The tube 42 may include a head end 44 and a foot end 46. A shaft 72 may extend upwardly from the head end 44. The shaft 72 may be rotatable relative to the head end 44.

A ratcheted surface 48 may be positioned proximate to the head end 44 of the tube 42. The ratcheted surface 48 is aligned with the exposed surface 28 of the upper end 26 of the first arm 24. The ratcheted surface 48 is threaded complementarily to the exposed surface 28 of the upper end 26 of the first arm 24 wherein the ratcheted surface 48 inhibits the tube 42 from pivoting along the axis extending between the front edge 18 and the rear edge 20 of the base 12 while the ratcheted surface 48 is positioned flush against the exposed surface 28.

A plug 50 may extend outwardly from the tube 42. The ratcheted surface 48 may surround the plug 50. The plug 50 generally has a size that is complementary to a size of the cavity 30. More generally, the plug 50 is positioned within the cavity 30. The plug 50 is generally movably positioned within the cavity 30 wherein the plug 50 can rotate within the cavity 30 when the tube 42 is pivoted over the base 12.

An ear 52 may be coupled to and extend outwardly from the plug 50. The ear 52 may have a size that is complementary to a size of the channel 32. More generally, the ear 52 is positioned within the channel 32 such that the ear 52 can move along the channel 32. For example, the ear 52 may move between the upper edge 54 and the lower edge 56 of the channel 32 when the tube 42 is pivoted along the axis extending between the front edge 18 and the rear edge 20 of the base 12. Accordingly, the channel 32 and the ear 52 may restrict the range of motion of the tube 42, inhibiting the tube 42 from pivoting more than 180.0° over the base 12 when the ratcheted surface 48 is spaced from the exposed surface 28.

A gear 58 may be rotatably coupled to the head end 44 of the tube 42. The gear 58 is generally aligned with the forward surface 38 of the upper end 26 of the second arm 34. For example, the gear 58 may include an outer surface 60 that faces away from the tube 42 toward the forward surface 38 of the upper end 26 of the second arm 34.

A plurality of grooves 62 may extend into the outer surface 60. Each cusp of the plurality of cusps 40 on the forward surface 38 of the top end 36 of the second arm 34 is generally positioned within a respective groove of the plurality of grooves 62. Each groove of the plurality of grooves 62 may be elongated. Accordingly, each cusp of the plurality of cusps 40 may slide along the respective groove of the plurality of grooves 62 when the gear 58 is rotated.

In certain embodiments, each groove of the plurality of grooves 62 may be sloped wherein each groove of the plurality of grooves 62 has a shallow end 64 and a deep end 66. The plurality of cusps 40 urge the tube 42 toward the first arm 24 such that the ratcheted surface 48 is positioned flush against the exposed surface 28 of the first arm 24 while the plurality of cusps 40 are positioned in the shallow end 64 of each groove of the plurality of grooves 62. Conversely, the plurality of cusps 40 release pressure on the tube 42 to space the ratcheted surface 48 from the exposed surface 28 of the first arm 24 when the plurality of cusps 40 are positioned in the deep end 66. In other words, rotation of the gear 58 to move the plurality of cusps 40 between the shallow end 64 and the deep end 66 of the plurality of grooves 62 may be considered as a locking mechanism to inhibit the tube 42 from pivoting over the base 12.

A holder 68 is coupled to the tube 42. The holder 68 is configured to couple a three-dimensional puzzle 70 to the tube 42. For example, a stem 74 may be positioned on the shaft 72 of the tube 42. When the plurality of cusps 40 are positioned in the deep end 66 of the plurality of grooves 62, the stem 74 generally rotates with the shaft 72 relative to the head end 44 of the tube 42. More specifically, an opening 108 may extend into the stem 74. The opening 108 generally has a shape that is complementary to a shape of the shaft 72 such that the shaft 72 is positioned within the opening 108.

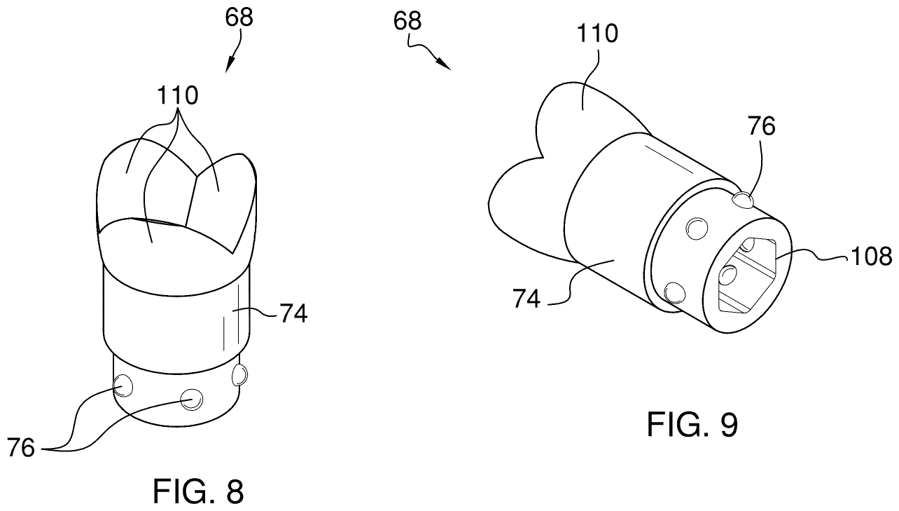

A plurality of petals 110 may be coupled to the stem 74. The plurality of petals 110 may be angled to extend upwardly from the stem 74 and outwardly away from each other wherein the plurality of petals 110 are configured for securing the three-dimensional puzzle 70 to the tube 42 above the base 12. For example, the plurality of petals 110 may define a shape that is complementary to a shape of the three-dimensional puzzle 70. In some such embodiments, the plurality of petals 110 may be configured to secure the three-dimensional puzzle 70 to the holder 68 via a friction fit. FIGS. 8 and 9 provide one exemplary embodiment of the holder 68, wherein the plurality of petals 110 includes three petals that are is configured to receive a corner piece of the three-dimensional puzzle 70.

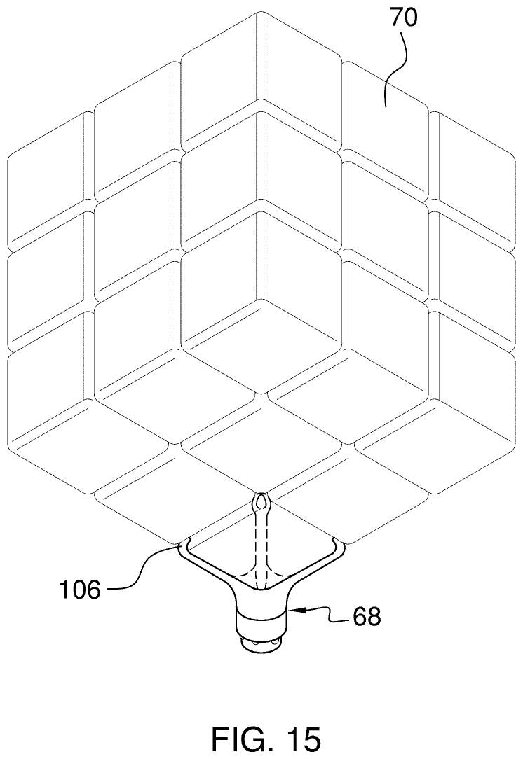

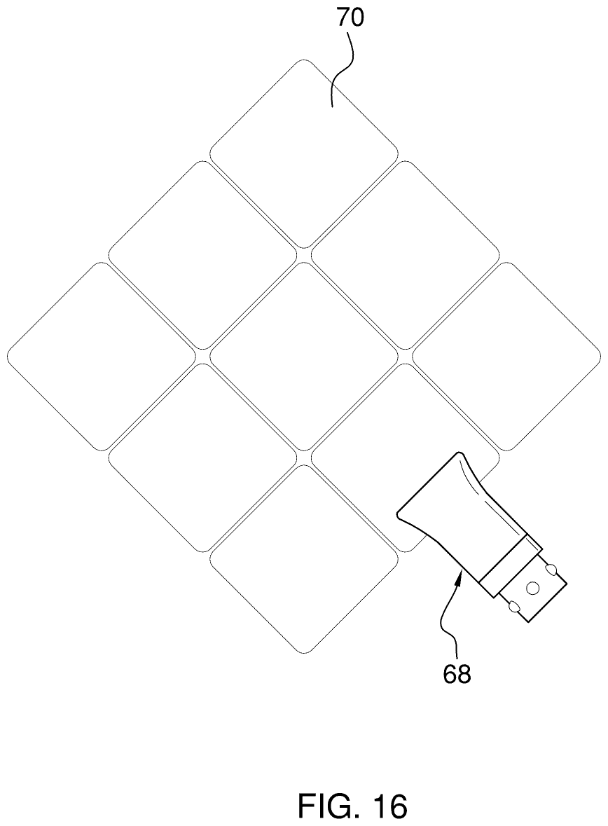

FIG. 15 provides another exemplary embodiment of the holder 68, wherein the plurality of petals 110 are elongated and spaced from each other. Such embodiments may also be configured to receive a corner piece of the three-dimensional puzzle 70, while a terminal end 106 of each petal of the plurality of petals 110 is positioned around respective corners of the corner piece of the three-dimensional puzzle 70. In other words, the terminal end 106 of each petal of the plurality of petals 110 may fit within gaps between adjacent pieces of the three-dimensional puzzle 70.

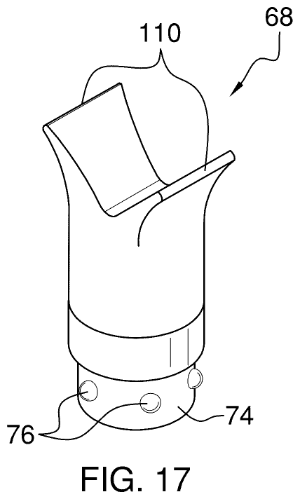

FIGS. 16 and 17 provide yet another exemplary embodiment of the holder 68. In such embodiments, the plurality of petals 110 includes two petals that form a V-shape configured to be secured to an edge of the three-dimensional puzzle 70.

In some embodiments, an adhesive material may be positioned on each petal of the plurality of petals 110 of the holder 68. The adhesive material is configured to adhesively engage the three-dimensional puzzle 70 to secure the three-dimensional puzzle 70 to the holder 68. Alternatively, the plurality of petals 110 may be chemically bonded to the three-dimensional puzzle 70, fasteners may be used to secure the plurality of petals 110 to the three-dimensional puzzle 70, and other coupling means are also contemplated.

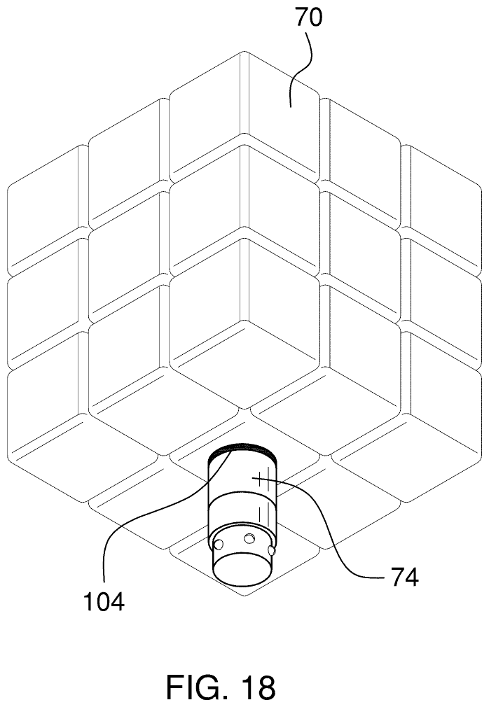

In certain embodiments, such as the embodiment shown in FIG. 18, the stem 74 may be configured to be positioned against a surface of the three-dimensional puzzle 70, for example because the stem 74 has a planar top wall 104 in place of the plurality of petals 110. The adhesive material may be positioned on the planar top wall 104 of the stem 74 to adhesively secure the stem 74 of the holder 68 to the surface of the three-dimensional puzzle 70. Such embodiments may also utilize chemical bonding, hook and loop fasteners, or other coupling means.

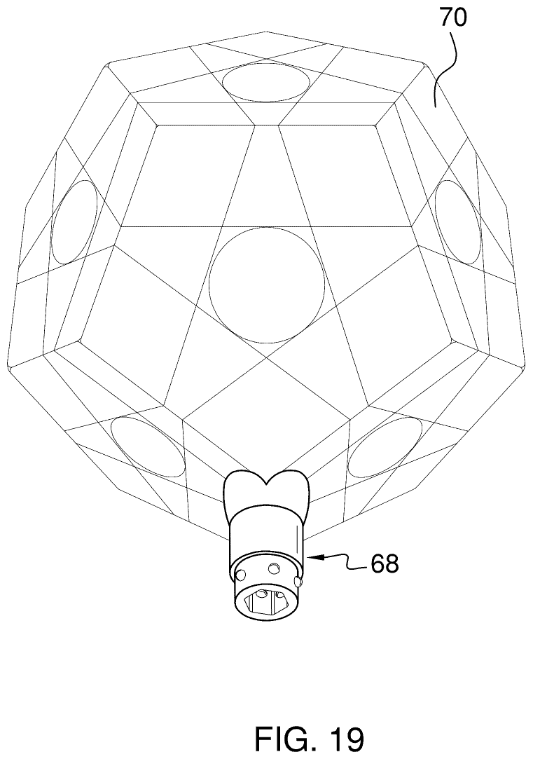

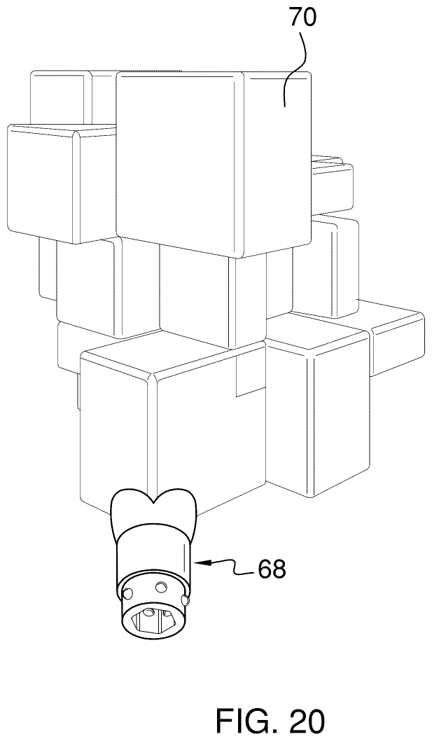

Numerous embodiments of the three-dimensional puzzle 70 are contemplated, particularly RUBIK'S CUBE® types of puzzles. The three-dimensional puzzle 70 may have the traditional cube shape, but which may also have numerous other types of shapes, such as those shown in FIGS. 19 and 20. Specific variations of the holder 68 may be chosen based on the specific embodiment of the three-dimensional puzzle 70 that the user wants to solve.

In certain embodiments, the holder 68 may be removably couplable to the tube 42. In some such embodiments, a friction fit between the stem 74 of the holder and the shaft 72 of the tube 42 may removably couple the holder 68 to the tube 42. Other such embodiments may include a release 80 that removably couples the holder 68 to the tube 42.

The release 80 may include a plurality of detents 76 that are coupled to the stem 74 of the holder 68. The plurality of detents 76 may be movably coupled to the stem 74 wherein the plurality of detents 76 are movable inwardly and outwardly relative to the stem 74. A plurality of indentations 78 may extend into the shaft 72 of the tube 42. The plurality of indentations 78 are generally alignable with the plurality of detents 76 wherein each detent of the plurality of detents 76 is positionable within an associated indentation of the plurality of indentations 78. The plurality of indentations 78 may have a shape that is complementary to a shape of the plurality of detents 76 wherein the plurality of detents 76 secure a position of the holder 68 relative to the shaft 72 when each detent of the plurality of detents 76 is positioned within the associated indentation of the plurality of indentations 78.

A collar 82 may be slidably coupled to the shaft 72 wherein the collar 82 is alternately positionable between a raised position 84 and a lowered position 86. The collar 82 is generally positioned to cover the plurality of detents 76 while the collar 82 is in the raised position 84. While the collar 82 is in the raised position, the collar 82 urges the plurality of detents 76 inwardly relative to the stem 74 to secure the plurality of detents 76 within the plurality of indentations 78 and inhibit the holder 68 from being removed from the shaft 72. While the collar 82 is in the lowered position, the collar 82 releases the plurality of detents 76 from the plurality of indentations 78 to facilitate removal of the holder 68 from the stem 74. A spring 88 may be coupled to the shaft 72 and the collar 82. The spring 88 is generally biased to expand upwardly and urge the collar 82 into the raised position 84. The spring 88 may be compressed while the collar 82 is in the lowered position 86, such that the spring 88 urges the collar 82 upwardly when pressure is not applied to the collar 82 to compress the spring 88.

A rotational lock 90 may be coupled to the tube 42. The rotational lock 90 selectively engages the shaft 72 to inhibit the shaft 72 from rotating relative to the head end 44 of the tube 42.

For example, a hub 92 may be slidably coupled to the shaft 72 wherein the hub 92 is alternately positionable between a locked position 112 and an unlocked position 114. The hub 92 is generally distally positioned on the shaft 72 relative to the plurality of indentations 78. In other words, the hub 92 is generally positioned proximate to the foot end 46 of the tube 42. A recess 94 may extend into the hub 92. The hub 92 may be threaded within the recess 94.

A wheel 96 may be coupled to the shaft 72. The wheel 96 is generally statically coupled to the shaft 72 wherein rotation of the shaft 72 rotates the wheel 96. The wheel 96 may have having a toothed surface 98 with a threading that is complementary to a threading of the hub 92 within the recess 94. The hub 92 may surround an entirety of the toothed surface 98 of the wheel 96 while the hub 92 is in the locked position 112. Complementary threading between the hub 92 and the toothed surface 98 of the wheel 96 inhibits the wheel 96 and the shaft 72 from rotating while the hub 92 is in the locked position 112. The toothed surface 98 of the wheel 96 is generally spaced from the threading within the recess 94 of the hub 92 while the hub 92 is in the unlocked position 114 to enable rotation of the wheel 96 and the shaft 72. For example, the toothed surface 98 of the wheel 96 may be exposed while the hub 92 is in the unlocked position 114.

A body 100 may be pivotably coupled to the hub 92. The body 100 may have a primary edge 116, a secondary edge 118, and a tertiary edge 120. In some embodiments, the primary edge 116 may be perpendicular to the secondary edge 118. Each of the primary edge 116 and the secondary edge 118 is alternately positionable against the hub 92. The tertiary edge 120 may be convexly arcuate between the primary edge 116 and the secondary edge 118. For example, the tertiary edge 120 may be arcuate wherein the tertiary edge 120 is configured to facilitate a user in pivoting the body 100 relative to the hub 92. The body 100 may be distally positioned on the hub 92 relative to the recess 94. The hub 92 is generally positioned adjacent to the foot end 46 of the tube 42.

A pin 102 may pivotably couple the body 100 to the hub 92. The pin 102 is generally positioned proximate to a junction between the primary edge 116 and the secondary edge 118 of the body 100. The pin 102 may be spaced from the secondary edge 118 by a distance exceeding a distance between the pin 102 and the primary edge 116. The body 100 urges the hub 92 upwardly into the locked position 112 when the secondary edge 118 is positioned against the hub 92. The body 100 releases pressure on the hub 92 to enable to the hub 92 to move downwardly into the unlocked position 114 when the primary edge 116 is positioned against the hub 92.

In use, the three-dimensional puzzle 70 can be removably coupled to the holder 68, while in alternative embodiments the three-dimensional puzzle 70 may be fixedly coupled to and unremovable from the holder 68. The tube 42 prevents the three-dimensional puzzle 70 from being flipped or turned without either pivoting the tube 42, rotating the shaft 72 relative to the head end 44 of the tube 42, or turning the base 12. Moreover, the ear 52 and the channel 32 can restrict the range of motion for pivoting the tube 42 relative to the base 12.

The gear 58 may be turned to push the ratcheted surface 48 on the tube 42 flush against the exposed surface 28 of the first arm 24. The complementary threading on the ratcheted surface 48 and the exposed surface 28 can prevent the tube 42 from being pivoted at all. The rotational lock 90 can be engaged by pivoting the body 100 and urging the hub 92 upwardly around the wheel 96, preventing the shaft 72 from being rotated relative to the head end 44 of the tube 42. Thus, the orientational movement of the three-dimensional puzzle 70 can be selectively restricted, based on the amount which the user wants to increase the difficulty of the three-dimensional puzzle 70.

When the three-dimensional puzzle 70 is fixedly coupled to the holder 68, the release 80 may be used to remove the three-dimensional puzzle 70 from the tube. In such embodiments, the three-dimensional puzzle 70 may be swapped out for another puzzle by re-attaching the holder 68 which is attached to that other puzzle to the tube 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A puzzle stand assembly comprising:
a base;
a first arm being coupled to the base;
a second arm being coupled to the base, the second arm being aligned with the first arm across the base;
a tube being coupled to the first arm and the second arm wherein the tube is suspended over the base between the first arm and the second arm, the tube being pivotably coupled to the first arm and the second arm wherein the tube is pivotable along an axis extending between a front edge and a rear edge of the base; and
a holder being coupled to the tube, the holder being configured to couple a three-dimensional puzzle to the tube.

2. The puzzle stand assembly of claim 1, the first arm further comprising:
an upper end having an exposed surface, the exposed surface being threaded; and
the tube further comprising:
a head end; and
a ratcheted surface being positioned proximate to the head end of the tube, the ratcheted surface being aligned with the exposed surface of the upper end of the first arm, the ratcheted surface being threaded complementarily to the exposed surface of the upper end of the first arm wherein the ratcheted surface inhibits the tube from being pivoted along the axis extending between the front edge and the rear edge of the base while the ratcheted surface is positioned flush against the exposed surface.

3. The puzzle stand assembly of claim 2, the second arm further comprising:
a top end having a forward surface; and
a plurality of cusps being positioned on the exposed surface of the upper end, the plurality of cusps extending outwardly from the exposed surface; and
the tube further comprising:
a gear being rotatably coupled to the head end, the gear being aligned with the forward surface of the upper end of the second arm; and
a plurality of grooves extending into an outer surface of the gear, each cusp of the plurality of cusps on the forward surface of the top end of the second arm being positioned within a respective groove of the plurality of grooves, each groove of the plurality of grooves being elongated wherein each cusp of the plurality of cusps slides along the respective groove of the plurality of grooves when the gear is rotated,

4. The puzzle stand assembly of claim 3, each groove of the plurality of grooves further comprising a shallow end and a deep end, the plurality of cusps urging the tube toward the first arm such that the ratcheted surface is positioned flush against the exposed surface of the first arm while the plurality of cusps are positioned in the shallow end of each groove of the plurality of grooves.

5. The puzzle stand assembly of claim 2, the first arm further comprising:
a cavity extending into the exposed surface of the first arm, the cavity being circular; and
a channel extending into the exposed surface of the first arm, the channel being positioned adjacent to the cavity, the channel having an upper edge and a lower edge, the upper edge being vertically aligned with the lower edge wherein the channel extends 180.0° around the cavity;
the tube further comprising:
a plug extending outwardly from the tube, the plug having a size being complementary to a size of the cavity wherein the plug is positioned within the cavity;
an ear being coupled to and extending outwardly from the plug, the ear having a size being complementary to a size of the channel wherein the ear is positioned within the channel, the ear moving between the upper edge and the lower edge of the channel when the tube is pivoted along the axis extending between the front edge and the rear edge of the base wherein the channel and the ear inhibit the tube from being pivoted more than 180.0° over the base when the ratcheted surface is spaced from the exposed surface.

6. The puzzle stand assembly of claim 1, the tube further comprising:
a head end; and
a shaft extending upwardly from the head end; and
the holder further comprising:
a stem being positionable on the shaft of the tube; and
an opening extending into the stem, the opening having a shape being complementary to a shape of the shaft wherein the shaft is positionable within the opening.

7. The puzzle stand assembly of claim 6, the holder further comprising a plurality of petals being coupled to the stem, the plurality of petals being angled to extend upwardly from the stem and outwardly away from each other wherein the plurality of petals are configured for securing the three-dimensional puzzle to the tube above the base.

8. The puzzle stand assembly of claim 7, wherein the plurality of petals define a shape being complementary to a shape of the three-dimensional puzzle wherein the plurality of petals are configured to secure the three-dimensional puzzle to the holder via a friction fit.

9. The puzzle stand assembly of claim 6, further comprising a release removably coupling the holder to the tube.

10. The puzzle stand assembly of claim 9, the release further comprising:
a plurality of detents being coupled to the stem of the holder, the plurality of detents being movably coupled to the stem wherein the plurality of detents are movable inwardly and outwardly relative to the stem; and
a plurality of indentations extending into the shaft of the tube, the plurality of indentations being alignable with the plurality of detents wherein each detent of the plurality of detents is positionable within an associated indentation of the plurality of indentations.

11. The puzzle stand assembly of claim 10, the release further comprising a collar being slidably coupled to the shaft wherein the collar is alternately positionable between a raised position and a lowered position, the collar being positioned to cover the plurality of detents while the collar is in the raised position, the collar urging the plurality of detents inwardly relative to the stem to secure the plurality of detents within the plurality of indentations and inhibit the holder from being removed from the shaft while the collar is in the raised position.

12. The puzzle stand assembly of claim 1, the tube further comprising a head end and a shaft extending upwardly from the head end, the shaft being rotatable relative to the head end, the puzzle stand assembly further comprising a rotational lock being coupled to the tube, the rotational lock selectively engaging the shaft to inhibit the shaft from being rotated relative to the head end of the tube.

13. The puzzle stand assembly of claim 12, the rotational lock further comprising:
a hub being slidably coupled to the shaft wherein the hub is alternately positionable between a locked position and an unlocked position;
a recess extending into the hub, the hub being threaded within the recess; and
a wheel being coupled to the shaft, the wheel being statically coupled to the shaft wherein rotation of the shaft rotates the wheel, the wheel having a toothed surface with a threading being complementary to a threading of the hub within the recess, the hub surrounding an entirety of the toothed surface of the wheel while the hub is in the locked position wherein the toothed surface of the wheel inhibits the wheel and the shaft from being rotated while the hub is in the locked position.

14. The puzzle stand assembly of claim 13, the rotational lock further comprising:
a body being pivotably coupled to the hub, the body having a primary edge and a secondary edge each of the primary edge and the secondary edge being alternately positionable against the hub; and
a pin pivotably coupling the body to the hub, the pin being positioned proximate to a junction between the primary edge and the secondary edge of the body, the pin being spaced from the secondary edge by a distance exceeding a distance between the pin and the primary edge wherein the body urges the hub upwardly into the locked position when the secondary edge is positioned against the hub.

15. A puzzle stand assembly comprising:
a base having a top side and a bottom side, the base having a front edge, a rear edge, and a pair of lateral edges being coupled to and extending between the front edge and the rear edge, the bottom side being planar wherein the bottom side is configured for being positioned on a surface;
a first arm being coupled to the base, the first arm being positioned proximate to a first lateral edge of the pair of lateral edges, the first arm including:
an upper end having an exposed surface facing away from the first lateral edge of the pair of lateral edges, the exposed surface being threaded;
a cavity extending into the exposed surface of the first arm, the cavity being circular; and
a channel extending into the exposed surface of the first arm, the channel being positioned adjacent to the cavity, the channel having an upper edge and a lower edge, the upper edge being vertically aligned with the lower edge wherein the channel extends 180.0° around the cavity;
a second arm being coupled to the base, the second arm being positioned proximate to a second lateral edge of the pair of lateral edges, the second arm being aligned with the first arm across the base, the second arm having a height being equal to a height of the first arm, the second arm including:
a top end having a forward surface facing away from the second lateral edge of the pair of lateral edges wherein the forward surface faces toward the exposed surface of the first arm; and
a plurality of cusps being positioned on the forward surface of the top end, the plurality of cusps extending outwardly from the forward surface, the plurality of cusps being spaced from each other;
a tube being coupled to the first arm and the second arm wherein the tube is suspended over the base between the first arm and the second arm, the tube being pivotably coupled to the first arm and the second arm wherein the tube is pivotable along an axis extending between the front edge and the rear edge of the base, the tube including:
a head end;
a foot end;
a shaft extending upwardly from the head end, the shaft being rotatable relative to the head end;
a ratcheted surface being positioned proximate to the head end of the case, the ratcheted surface being aligned with the exposed surface of the upper end of the first arm, the ratcheted surface being threaded complementarily to the exposed surface of the upper end of the first arm wherein the ratcheted surface inhibits the tube from being pivoted along the axis extending between the front edge and the rear edge of the base while the ratcheted surface is positioned flush against the exposed surface;
a plug extending outwardly from the tube, the ratcheted surface surrounding the plug, the plug having a size being complementary to a size of the cavity wherein the plug is positioned within the cavity;
an ear being coupled to and extending outwardly from the plug, the ear having a size being complementary to a size of the channel wherein the ear is positioned within the channel, the ear moving between the upper edge and the lower edge of the channel when the tube is pivoted along the axis extending between the front edge and the rear edge of the base wherein the channel and the ear inhibit the tube from being rotated more than 180.0° when the ratcheted surface is spaced from the exposed surface; and
a gear being rotatably coupled to the head end, the gear being aligned with the forward surface of the upper end of the second arm, the gear including:
an outer surface facing away from the tube toward the forward surface of the upper end of the second arm; and
a plurality of grooves extending into the outer surface, each cusp of the plurality of cusps on the forward surface of the upper end of the second arm being positioned within a respective groove of the plurality of grooves, each groove of the plurality of grooves being elongated wherein each cusp of the plurality of cusps slides along the respective groove of the plurality of grooves when the gear is rotated, each groove of the plurality of grooves being sloped wherein each groove of the plurality of grooves has a shallow end and a deep end, the plurality of cusps urging the tube toward the first arm such that the ratcheted surface is positioned flush against the exposed surface of the first arm while the plurality of cusps are positioned in the shallow end of each groove of the plurality of grooves, the plurality of cusps releasing pressure on the tube to space the ratcheted surface from the exposed surface of the first arm when the plurality of cusps are positioned in the deep end;
a holder being couplable to the tube, the holder being configured to couple a three-dimensional puzzle to the tube, the holder including:
a stem being positionable on the shaft of the tube;
an opening extending into the stem, the opening having a shape being complementary to a shape of the shaft wherein the shaft is positionable within the opening; and
a plurality of petals being coupled to the stem, the plurality of petals being angled to extend upwardly from the stem and outwardly away from each other wherein the plurality of petals are configured for securing the three-dimensional puzzle to the tube above the base, the plurality of petals defining a shape being complementary to a shape of the three-dimensional puzzle wherein the plurality of petals are configured to secure the three-dimensional puzzle to the holder via a friction fit;
a release removably coupling the holder to the tube, the release including:
a plurality of detents being coupled to the stem of the holder, the plurality of detents being movably coupled to the stem wherein the plurality of detents are movable inwardly and outwardly relative to the stem;
a plurality of indentations extending into the shaft of the tube, the plurality of indentations being alignable with the plurality of detents wherein each detent of the plurality of detents is positionable within an associated indentation of the plurality of indentations, the plurality of indentations having a shape being complementary to a shape of the plurality of detents wherein the plurality of detents secure a position of the holder relative to the shaft when each detent of the plurality of detents is positioned within the associated indentation of the plurality of indentations;
a collar being slidably coupled to the shaft wherein the collar is alternately positionable between a raised position and a lowered position, the collar being positioned to cover the plurality of detents while the collar is in the raised position, the collar urging the plurality of detents inwardly relative to the stem to secure the plurality of detents within the plurality of indentations and inhibit the holder from being removed from the shaft while the collar is in the raised position, the collar releasing the plurality of detents from the plurality of indentations while the collar is in the lowered position to facilitate removal of the holder from the stem; and
a spring being coupled to the shaft and the collar, the spring being biased to expand upwardly and urge the collar into the raised position, the spring being compressed while the collar is in the lowered position; and
a rotational lock being coupled to the tube, the rotational lock selectively engaging the shaft to inhibit the shaft from being rotated relative to the head end of the tube, the rotational lock including:
a hub being slidably coupled to the shaft wherein the hub is alternately positionable between a locked position and an unlocked position, the hub being distally positioned on the shaft relative to the plurality of indentations;
a recess extending into the hub, the hub being threaded within the recess;
a wheel being coupled to the shaft, the wheel being statically coupled to the shaft wherein rotation of the shaft rotates the wheel, the wheel having a toothed surface with a threading being complementary to a threading of the hub within the recess, the hub surrounding an entirety of the toothed surface of the wheel while the hub is in the locked position wherein the toothed surface of the wheel inhibits the wheel and the shaft from being rotated while the hub is in the locked position, the toothed surface of the wheel being exposed while the hub is in the unlocked position to enable rotation of the wheel and the shaft;
a body being pivotably coupled to the hub, the body having a primary edge, a secondary edge, and a tertiary edge, each of the primary edge and the secondary edge being alternately positionable against the hub, the tertiary edge being convexly arcuate between the primary edge and the secondary edge, the body being distally positioned on the hub relative to the recess; and
a pin pivotably coupling the body to the hub, the pin being positioned proximate to a junction between the primary edge and the secondary edge of the body, the pin being spaced from the secondary edge by a distance exceeding a distance between the pin and the primary edge wherein the body urges the hub upwardly into the locked position when the secondary edge is positioned against the hub, the body releasing the hub to enable to the hub to move downwardly into the unlocked position when the primary edge is positioned against the hub.
